(19) United States
(12) Patent Application Publication
(10) Pub. No.: US 2017/0094916 A1
(43) Pub. Date: Apr. 6, 2017

(54) MULTI-FLOW SYSTEM

(71) Applicant: Richard Hansen, Austin, TX (US)

(72) Inventor: Richard Hansen, Austin, TX (US)

(21) Appl. No.: 15/276,653

(22) Filed: Sep. 26, 2016

Related U.S. Application Data
(60) Provisional application No. 62/237,618, filed on Oct. 6, 2015.

(51) Int. Cl. A01G 25/00; B05B 1/30; B05B 1/14

(52) U.S. Cl. CPC A01G 25/00; B05B 1/14; B05B 1/30

(57) ABSTRACT

The irrigation system includes a threaded neck, a main chamber, a 360-degree tube coupling, a set of directional flow tubes, a flow tube nozzle adjustment, a chamber pressure control, and a pulse flow control dial. The multi-flow system is useful for providing a direct watering system in a garden will not damage or over-water plants. Further, the system decreases water loss, and helps maintain proper plant health by adding fertilizer to the system if so desired.

### CROSS-REFERENCE TO RELATED APPLICATION

The present application is related to and claims priority to U.S. Provisional Patent Application No. 62/237,618 filed Oct. 6, 2015, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

1. Field of the Invention

The present invention relates generally to the field of sprinkler systems and more specifically relates to sprinkler replacement heads.

2. Description of Related Art

Irrigation sprinklers are sprinklers providing irrigation to agriculture, crops, and vegetation. They are also used for recreation, as another type cooling system, or for the control of airborne dust, landscaping, and golf courses. Sprinkler irrigation is a method of applying irrigation water which is similar to natural rainfall. Water is distributed through a system of pipes usually by pumping. It is then sprayed into the air through sprinklers so that it breaks up into small water drops which fall to the ground. The pump supply system, sprinklers and operating conditions must be designed to enable a uniform application of water. However, this type of watering system is not suitable for a garden setting. Some plants may need more water than others, and the water itself may damage young plants preventing their growth, or possibly killing the plants due to over-watering which is not desirable.

Home lawn sprinklers vary widely in their size, cost, and complexity. They include impact sprinklers, oscillating sprinklers, drip sprinklers, and underground sprinkler systems. Other systems may be professionally installed permanently in the ground and are attached directly to a home's plumbing system. Most irrigation sprinklers are used as part of a sprinkler system, consisting of various plumbing parts, pump unit, piping and control equipment. Watering a garden requires more finesse than a traditional sprinkler system can provide. A suitable solution is desired.

U.S. Pat. No. 5,826,803 to Randy J. Cooper relates to a sprinkler replacement head. The described sprinkler replacement head includes a lawn and garden sprinkler which has a manifold with one or more bendable tubes extending therefrom. The tubes can be bent to direct one or more streams of water to a desired location. In a preferred design, there is an internal water flow restrictor which permits a larger flow of water from some tubes than others so that a maximum control of water dispersion is obtained. Further, the bendable tubes are made from a flexible material and have a ductile wire within them.

### BRIEF SUMMARY OF THE INVENTION

In view of the foregoing disadvantages inherent in the known sprinkler system art, the present disclosure provides a novel multi-flow system. The general purpose of the present disclosure, which will be described subsequently in greater detail, is to provide a multi-flow system for providing water to a garden.

An irrigation system is disclosed herein. The irrigation system includes a threaded neck, a main chamber, a 360-degree tube coupling, a set of directional flow tubes, a flow tube nozzle adjustment, a chamber pressure control, and a pulse flow control dial. The threaded neck fits standard riser thread configurations, with the main chamber accepting irrigation water flow at a standard pressure. The main chamber internal geometry ensures flow to the 360-degree tube coupling is evenly distributed for each of the directional flow tubes. The 360-degree tube coupling can be bent to point in any direction without use of excessive force. The directional flow tubes are able to be easily replaced if damaged.

The flow tube nozzle adjustment is determined by specific tube end cap diameters, and the chamber pressure control contains an integrated dial valve for controlling pressure and flow from the main chamber to the directional flow tubes. The integrated dial valve is adjustable and can be set anywhere from low to high pressure, allowing for precise irrigation to a specific plant. The pulse flow control dial allows for the directional flow tubes to release water at intermittent intervals.

The main chamber can be filled with fertilizer that is released slowly in conjunction with the pulse flow control dial. The pulse flow control dial is able to be electronically programmed to deliver nutrients for maintaining specific plant needs. The threaded neck is able to be outfitted with a universal threaded adapter. The pulse flow control dial controls intermittent water release of each directional flow tube independently, so that certain tubes may be turned completely off. The set of directional flow tubes include a nozzle for independently adjusting between wide, and alternately, narrow flow. The pulse flow control can be operated remotely to maintain plant health from an off-site location.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a multi-flow system, constructed and operative according to the teachings of the present disclosure.

FIG. 1 is a perspective view of the irrigation system during an ‘in-use’ condition, according to an embodiment of the disclosure.

FIG. 2 is a front view of the irrigation system of FIG. 1, according to an embodiment of the present disclosure.

FIG. 3 is an internal view of the irrigation system of FIG. 1, according to an embodiment of the present disclosure.

FIG. 4 is a cut away view of the irrigation system of FIG. 1, according to an embodiment of the present disclosure.

FIG. 5 is a flow diagram illustrating a method of use for multi-flow system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a sprinkler system and more particularly to a multi-flow system as used to improve the current irrigation system, and more accurately water plants contained within a garden.

Generally, the multi-flow system nozzle is a retrofit plant/garden irrigation device that replaces the traditional spray nozzle on pop-up and fixed sprinkler risers for a more controlled and direct delivery of water to plant life. Usage of the multi-flow nozzle results in healthier plants while simultaneously reducing water usage. Traditional sprinkler risers with conventional nozzle attachments have broad, turbulent spray patterns that waste water. The spray action from such nozzles creates a wide variety of droplets, including tiny mist or aerosol-like particles that evaporate into the air or drift from the target before reaching the plant area. Further, the conventional nozzle is not focused on specific plant targets and delivers a significant amount of the water to non-growing landscape features, such as rocks, mulch, walkways or even bare dirt, where water may actually facilitate weed growth. Some landscapers or homeowners may consider a drip irrigation system, but these systems have many drawbacks because they have numerous components that require assembly, requiring extensive design, construction, digging time and effort, and are susceptible to damage, clogging, and loss because of their placement on the soil amidst growing plant life.

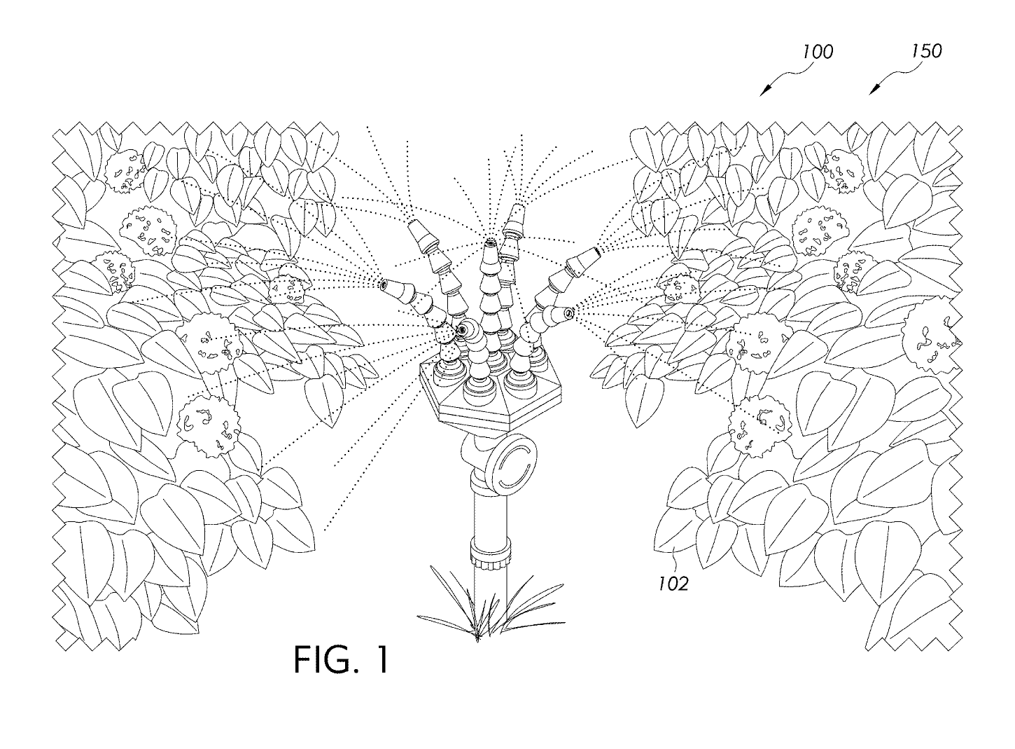

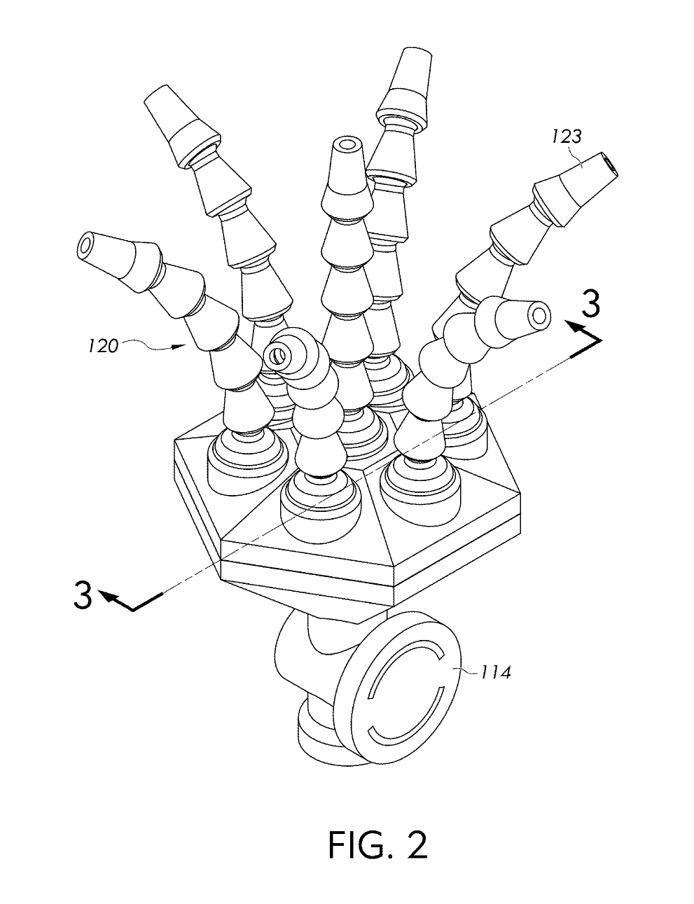

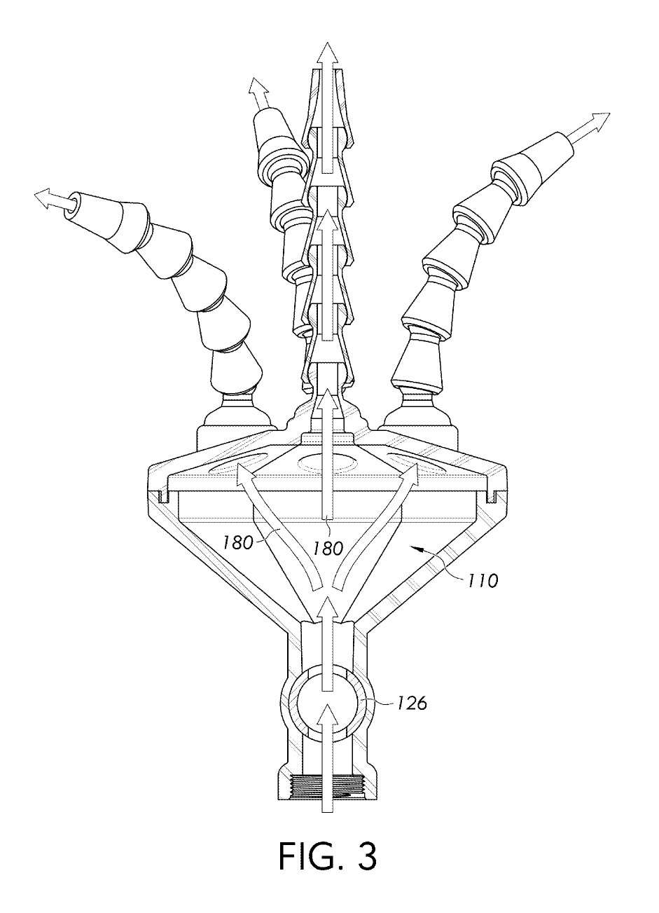

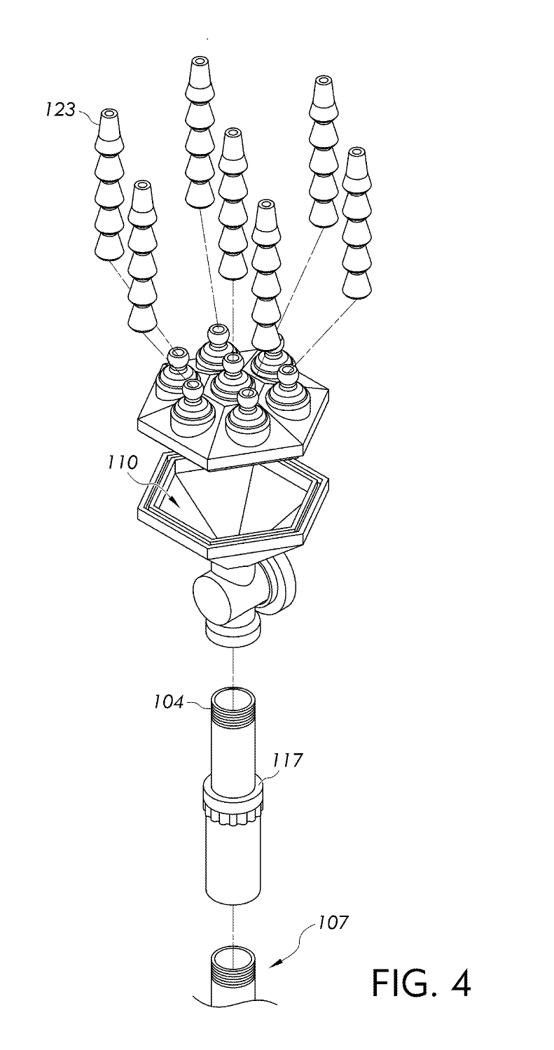

Referring now more specifically to the drawings by numerals of reference, there is shown in FIGS. 1-4, various views of an irrigation system entitled: multi-flow system 100. FIG. 1 shows a multi-flow system during an ‘in-use’ condition 150, according to an embodiment of the present disclosure. Here, the multi-flow system may be beneficial for use by a user 140 to provide a direct watering system in a garden which will not damage or over-water plants.

As illustrated, the irrigation system entitled: multi-flow system 100 may include threaded neck 104; threaded neck 104 fits standard riser 107 thread configurations, threaded neck 104 is alterably able to be outfitted with a universal threaded adapter. Main chamber 110 accepts irrigation water flow 180 in a standard pressure configuration. Integrated dial valve 114 is adjustable and can be set anywhere from low to high pressure allowing for precise irrigation water flow 180 to a specific plant 102, also main chamber 110 can be filled with fertilizer which is released slowly in conjunction with the pulse flow control dial (not shown).

Main chamber 110 is coupled to the threaded neck 104, includes a 360-degree tube coupling 117, which can be bent to point in any direction without use of excessive force. Directional flow tubes 120 are designed of segmented interconnecting links for allowing easy movement and replaced if damaged. Main chamber 110 internal geometry ensures flow from the 360-degree tube coupling 117 is evenly distributed to each of the directional flow tubes 120. Directional flow tubes 120 include a nozzle 123 for independently adjusting between wide, and alternately, narrow flow. Multi-flow system 100 including all inner and outer workings can be operated remotely to maintain plant 102 health from an off-site location.

Directional flow tube 120 nozzle 123 adjustment is determined by specific tube end cap diameters. Chamber pressure control, in determined by chamber pressure control dial valve 126 which when turned allows controlling of the pressure and flow from the main chamber 110 to the directional flow tubes 120, The pulse flow control dial (not shown) allows for the directional flow tubes 120 to release water at intermittent intervals. Multi-flow system 100 is electronically programmable to deliver nutrients for maintaining specific plant needs. The pulse flow control dial (not shown) controls intermittent water release of each directional flow tube 120 independently,

According to one embodiment, the multi-flow system 100 may be arranged as a kit 105. In particular, the multi-flow system 100 may further include a set of instructions 155. The instructions 155 may detail functional relationships in relation to the structure of the multi-flow system 100 (such that the multi-flow system 100 can be used, maintained, or the like, in a preferred manner).

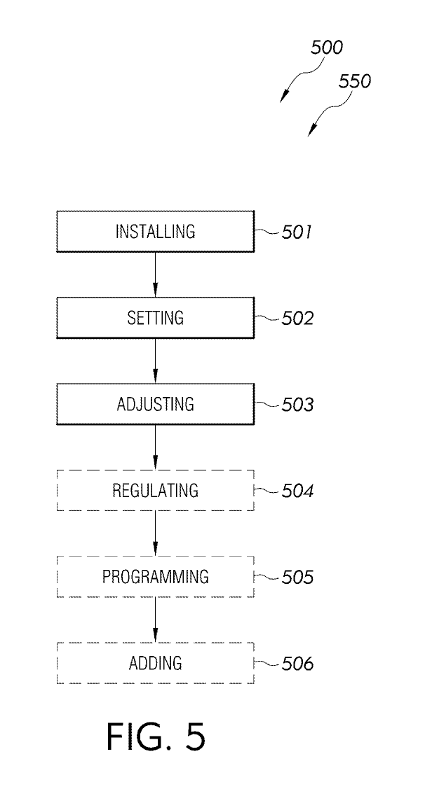

FIG. 5 is a flow diagram 550 illustrating a method 500 for using a direct watering system in a garden which will not damage or over-water plants, according to an embodiment of the present disclosure. In particular, the method 500 for irrigation system may include one or more components or features of the multi-flow system 100 as described above. As illustrated, the method for controlled watering of individual plants using a single existing sprinkler head 500 may include the steps of: step one 501, installing a threaded neck to a standard irrigation riser; step two 502, setting an integrated dial valve for low/high pressure; step three 503, adjusting a directional flow tube; step four 504, regulating a pulse flow control dial; step five 505, programming a pulse flow control dial electronically; and step six 506, adding fertilizer to a main chamber.

It should be noted that steps 504, 505 and 506 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for providing a direct watering system in a garden which will not damage or over-water plants (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An irrigation system, the system comprising:
a threaded neck;
a main chamber; the main chamber coupled to the threaded neck, the main chamber including;
a 360-degree tube coupling,
a set of directional flow tubes,
a flow tube nozzle adjustment,
a chamber pressure control, and
a pulse flow control dial.

2. The system of claim 1, wherein the threaded neck fits standard riser thread configurations.

3. The system of claim 1, wherein the main chamber accepts irrigation water flow at a standard pressure.

4. The system of claim 3, wherein the main chamber internal geometry ensures flow to the 360-degree tube coupling is evenly distributed for each of the directional flow tubes.

5. The system of claim 4, wherein the 360-degree tube coupling can be bent to point in any direction without use of excessive force.

6. The system of claim 4, wherein the directional flow tubes are able to be easily replaced if damaged.

7. The system of claim 6, wherein the flow tube nozzle adjustment is determined by specific tube end cap diameters.

8. The system of claim 1, wherein the chamber pressure control contains an integrated dial valve for controlling pressure and flow from the main chamber to the directional flow tubes.

9. The system of claim 8, wherein the integrated dial valve is adjustable and can be set anywhere from low to high pressure allowing for precise irrigation to a specific plant.

10. The system of claim 1, wherein the pulse flow control dial allows for the directional flow tubes to release water at intermittent intervals.

11. The system of claim 4, wherein the main chamber can be filled with fertilizer that is released slowly in conjunction with the pulse flow control dial.

12. The system of claim 10, wherein the pulse flow control dial is able to be electronically programmed to deliver nutrients for maintaining specific plant needs.

13. The system of claim 2, wherein the threaded neck is able to be outfitted with a universal threaded adapter.

14. The system of claim 10, wherein the pulse flow control dial controls intermittent water release of each said directional flow tube independently.

15. The system of claim 10, wherein the pulse flow control can be operated remotely to maintain plant health from an off site location.

16. The system of claim 6, wherein the set of directional flow tubes include a nozzle for independently adjusting between wide, and alternately, narrow flow.

17. A multi-flow system, the system comprising:
a threaded neck;
wherein the threaded neck fits standard riser thread configurations,
wherein the threaded neck is able to be outfitted with a universal threaded adapter,
a main chamber; wherein the main chamber accepts irrigation water flow at a standard pressure;
wherein the integrated dial valve is adjustable and can be set anywhere from low to high pressure allowing for precise irrigation to a specific plant,
wherein the main chamber can be filled with fertilizer that is released slowly in conjunction with the pulse flow control dial,
the main chamber coupled to the threaded neck, the main chamber including;
a 360-degree tube coupling,
wherein the 360-degree tube coupling can be bent to point in any direction without use of excessive force,
wherein the directional flow tubes are able to be easily replaced if damaged,
a set of directional flow tubes,
wherein the main chamber internal geometry ensures flow to the 360-degree tube coupling is evenly distributed for each of the directional flow tubes,
wherein the set of directional flow tubes include a nozzle for independently adjusting between wide, and alternately, narrow flow,
wherein the pulse flow control can be operated remotely to maintain plant health from an off-site location,
a flow tube nozzle adjustment,
wherein the flow tube nozzle adjustment is determined by specific tube end cap diameters,
a chamber pressure control, and
wherein the chamber pressure control contains an integrated dial valve for controlling pressure and flow from the main chamber to the directional flow tubes,
a pulse flow control dial,
wherein the pulse flow control dial allows for the directional flow tubes to release water at intermittent intervals,
wherein the pulse flow control dial is able to be electronically programmed to deliver nutrients for maintaining specific plant needs,
wherein the pulse flow control dial controls intermittent water release of each said directional flow tube independently, and
wherein the pulse flow control can be operated remotely to maintain plant health from an off-site location.

18. The system of claim 17, further comprising set of instructions; and
wherein the system is arranged as a kit.

19. A method of using the multi-flow system, the method comprising the steps of:
installing a threaded neck to a standard irrigation riser,
setting an integrated dial valve for low/high pressure,
adjusting a directional flow tube, and
regulating a pulse flow control dial.

20. The method of claim 19, further comprising the steps of:
programming a pulse flow control dial electronically, and
adding fertilizer to a main chamber.
